(19) United States
(12) Patent Application Publication
(10) Pub. No.: US 2021/0176912 A1
(43) Pub. Date: Jun. 17, 2021

(54) SYSTEM AND METHOD FOR ASSESSING AGRICULTURAL OPERATION PERFORMANCE BASED ON IMAGE DATA OF PROCESSED AND UNPROCESSED PORTIONS OF THE FIELD

(71) Applicant: CNH Industrial America LLC, New Holland, PA (US)

(72) Inventor: Joshua David Harmon, Leola, PA (US)

(73) Assignee: CNH INDUSTRIAL AMERICA LLC

(21) Appl. No.: 16/715,133

(22) Filed: Dec. 16, 2019

(51) Int. Cl. A01B 79/00; G06K 9/00; A01B 63/14

(52) U.S. Cl. CPC A01B 79/005; A01B 63/14; G06K 9/00791

(57) ABSTRACT

A system for assessing agricultural operation performance may include an imaging device configured to capture image data associated with a portion of a field present within a field of view. The field of view may, in turn, include a first section directed at one of a processed or an unprocessed portion of the field and a second section directed at the other of the processed or the unprocessed portion of the field. Furthermore, a controller may be configured to determine a first value of a field characteristic for the processed portion of the field based on a first portion of the image data associated with the processed portion of the field. Additionally, the controller may be configured to determine a second value of a field characteristic for the unprocessed portion of the field based on a second portion of the image data associated with the unprocessed portion of the field.

### FIELD OF THE INVENTION

The present disclosure generally relates to systems and methods for assessing the performance of agricultural operations and, more particularly, to systems and methods for assessing the performance of agricultural operations based on image data associated with of the processed portion of the field and the unprocessed portion of the field.

### BACKGROUND OF THE INVENTION

Agricultural implements, such as planters, seeders, tillage implements, and/or the like, are typically configured to perform an agricultural operation within a field, such as a planting/seeding operation, a tillage operation, and/or the like. When performing an agricultural operation, variations in field conditions may potentially impact the effectiveness and/or efficiency of the operation. As such, it is generally desirable to assess the performance of an agricultural operation as the operation is being performed. In this regard, systems have been developed for assessing the performance of an agricultural operation as the implement is traveling across the field. However, further improvements to such systems are needed.

Accordingly, an improved system and method for assessing agricultural operation performance would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for assessing agricultural operation performance. The system may include an imaging device installed on a work vehicle or an agricultural implement, with the imaging device configured to capture image data associated with a portion of a field present within a field of view of the imaging device. The field of view may, in turn, include a first section directed at one of a processed portion of the field or an unprocessed portion of the field and a second section directed at the other of the processed portion of the field or the unprocessed portion of the field. Furthermore, the system may include a controller communicatively coupled to the imaging device. As such, the controller may be configured to determine a first value of a field characteristic for the processed portion of the field based on a first portion of the image data that is associated with the processed portion of the field. Additionally, the controller may be configured to determine a second value of a field characteristic for the unprocessed portion of the field based on a second portion of the image data that is associated with the unprocessed portion of the field.

In another aspect, the present subject matter is directed to a method for assessing agricultural operation performance. The method may include receiving, with one or more computing devices, image data captured by an imaging device having a field of view including a first section directed at one of a processed portion of a field or an unprocessed portion of the field and a second section directed at the other of the processed portion of the field or the unprocessed portion of the field. Furthermore, the method may include determining, with the one or more computing devices, a first value of a field characteristic for the processed portion of the field based on a first portion of the received image data that is associated with the processed portion of the field. Additionally, the method may include determining, with the one or more computing devices, a second value of a field characteristic for the unprocessed portion of the field based on a second portion of the received image data that is associated with the unprocessed portion of the field. Moreover, the method may include comparing, with the one or more computing devices, the first value of the field characteristic and the second value of the field characteristic to determine a field characteristic differential associated with the performance of the agricultural operation. In addition, the method may include actively adjusting, with the one or more computing devices, an operating parameter of at least one of a work vehicle or an agricultural implement being used to process the field based on the determined field characteristic differential.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle towing an agricultural implement in accordance with aspects of the present subject matter;

FIG. 2 illustrates a perspective view of the implement shown in FIG. 1;

FIG. 3 illustrates a top view of one embodiment of an imaging device installed on a work vehicle or an agricultural implement in accordance with aspects of the present subject matter, particularly illustrating the field of view of the imaging device;

FIG. 4 illustrates a schematic view of one embodiment of a system for assessing agricultural operation performance in accordance with aspects of the present subject matter;

FIG. 5 illustrates a diagrammatic view of a work vehicle towing an agricultural implement across a field in accordance with aspects of the present subject matter, particularly illustrating an imaging device installed on the implement and configured to capture image data associated with a processed portion of the field and an unprocessed portion of the field; and

FIG. 6 illustrates a flow diagram of one embodiment of a method for assessing agricultural operation performance in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for assessing agricultural operation performance. In several embodiments, the system may include an imaging device installed on a work vehicle or an agricultural implement such that the imaging device has a field of view directed a portion of a field adjacent to the vehicle/implement. Specifically, the field of view of the imaging device may include a first section directed at one of a processed portion of the field (e.g., a portion of the field on which an agricultural operation has already been performed) or an unprocessed portion of the field (e.g., a portion of the field on which the agricultural operation has not yet been performed). Moreover, the field of view of the imaging device may include a second section directed at the other of the processed portion of the field or the unprocessed portion of the field.

In accordance with aspects of the present subject matter, a controller of the disclosed system may be configured to assess the performance of an agricultural operation being performed by the implement based on image data captured by the imaging device. Specifically, in several embodiments, as the implement is moved across the field to perform an agricultural operation thereon, the controller may be configured to receive image data from the imaging device. The received image data may, in turn, include a first portion associated with the processed portion of the field and a second portion associated with the unprocessed portion of the field. As such, in one embodiment, the controller may be configured to partition the received image data into the first and second portions. Furthermore, the controller may be configured to determine a first value of a characteristic (e.g., soil roughness, clod size, or residue coverage) of the processed portion of the field based on a first portion of the received image data. Similarly, the controller may be configured to determine a second value of the field characteristic of the unprocessed portion of the field based on a second portion of the received image data. Thereafter, the controller may be configured to compare the determined first and second values of the field characteristic to determine a field characteristic differential. Such differential may, in turn, be associated with or otherwise indicative of the performance of the agricultural operation.

Thus, the disclosed systems and methods may enable a single imaging device (e.g., a camera) to simultaneously capture image data indicative of a processed portion of the field and an unprocessed portion of the field. This, in turn, reduces the number of imaging devices needed to capture image data for assessing the performance of an agricultural operation, thereby decreasing the amount of data captured and, as a result, the amount of processing power and memory needed to analyze/process such data.

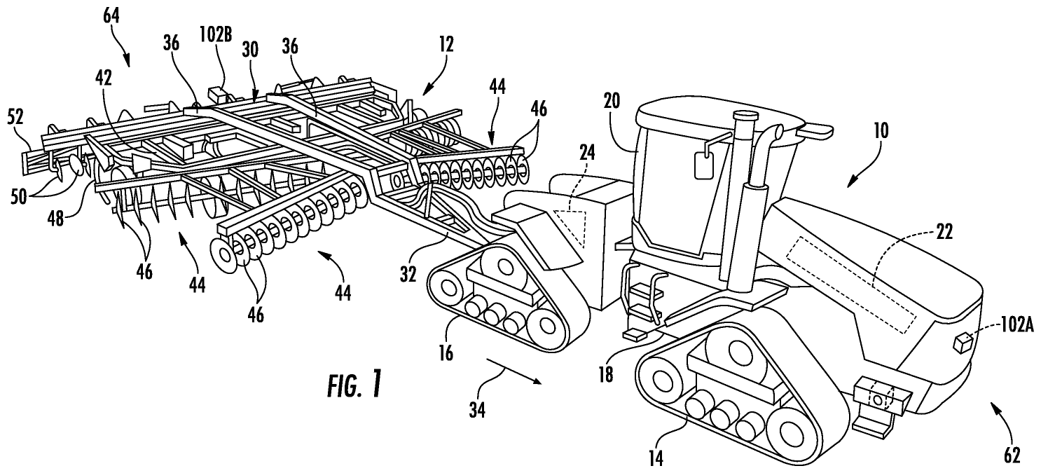

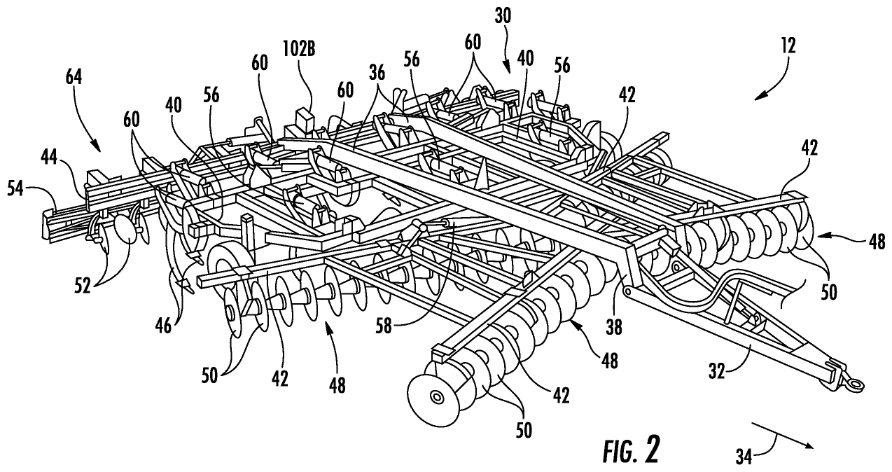

Referring now to drawings, FIGS. 1 and 2 illustrate perspective views of one embodiment of a work vehicle 10 and an associated agricultural implement 12 in accordance with aspects of the present subject matter. Specifically, FIG. 1 illustrates a perspective view of the work vehicle 10 towing the implement 12 (e.g., across a field). Additionally, FIG. 2 illustrates a perspective view of the implement 12 shown in FIG. 1. As shown, in the illustrated embodiment, the work vehicle 10 is configured as an agricultural tractor and the implement 12 is configured as a tillage implement. However, in other embodiments, the work vehicle 10 may be configured as any other suitable agricultural vehicle. Furthermore, in alternative embodiments, the implement 12 may be configured as any other suitable agricultural implement.

As particularly shown in FIG. 1, the work vehicle 10 includes a pair of front track assemblies 14 (one is shown), a pair or rear track assemblies 16 (one is shown), and a frame or chassis 18 coupled to and supported by the track assemblies 14, 16. An operator's cab 20 may be supported by a portion of the chassis 18 and may house various input devices for permitting an operator to control the operation of one or more components of the work vehicle 10 and/or one or more components of the implement 12. Additionally, the work vehicle 10 may include an engine 22 and a transmission 24 mounted on the chassis 18. The transmission 24 may be operably coupled to the engine 22 and may provide variably adjusted gear ratios for transferring engine power to the track assemblies 14, 16 via a drive axle assembly (not shown) (or via axles if multiple drive axles are employed).

Moreover, as shown in FIGS. 1 and 2, the implement 12 may generally include a carriage frame assembly 30 configured to be towed by the work vehicle 10 via a pull hitch or tow bar 32 in a travel direction of the vehicle (e.g., as indicated by arrow 34). In general, the carriage frame assembly 30 may be configured to support a plurality of ground-engaging tools, such as a plurality of shanks, disk blades, leveling blades, basket assemblies, and/or the like. In several embodiments, the various ground-engaging tools may be configured to perform a tillage operation across the field along which the implement 12 is being towed.

As particularly shown in FIG. 2, the carriage frame assembly 30 may include aft extending carrier frame members 36 coupled to the tow bar 32. In addition, reinforcing gusset plates 38 may be used to strengthen the connection between the tow bar 32 and the carrier frame members 36. In several embodiments, the carriage frame assembly 30 may support a central frame 40, a forward frame 42 positioned forward of the central frame 40 in the direction of travel 34, and an aft frame 44 positioned aft of the central frame 40 in the direction of travel 34. As shown in FIG. 2, in one embodiment, the central frame 40 may correspond to a shank frame configured to support a plurality of ground-engaging shanks 46. In such an embodiment, the shanks 46 may be configured to till the soil as the implement 12 is towed across the field. However, in other embodiments, the central frame 40 may be configured to support any other suitable ground-engaging tool(s).

Additionally, as shown in FIG. 2, in one embodiment, the forward frame 42 may correspond to a disk frame configured to support various gangs or sets 48 of disk blades 50. In such an embodiment, each disk blade 50 may, for example, include both a concave side (not shown) and a convex side (not shown). In addition, the various gangs 48 of disk blades 50 may be oriented at an angle relative to the travel direction 34 of the work vehicle 10 to promote more effective tilling of the soil. However, in other embodiments, the forward frame 42 may be configured to support any other suitable ground-engaging tools.

Moreover, like the central and forward frames 40, 42, the aft frame 44 may also be configured to support a plurality of ground-engaging tools. For instance, in the illustrated embodiment, the aft frame 44 is configured to support a plurality of leveling blades 52 and rolling (or crumbler) basket assemblies 54. However, in other embodiments, any other suitable ground-engaging tools may be coupled to and supported by the aft frame 44, such as a plurality closing disks.

In addition, the implement 12 may also include any number of suitable actuators (e.g., hydraulic cylinders) for adjusting the relative positioning of, penetration depth of, and/or force applied to the various ground-engaging tools 46, 50, 52, 54. For instance, the implement 12 may include one or more first actuators 56 coupled to the central frame 40 for raising or lowering the central frame 40 relative to the ground, thereby allowing the penetration depth of and/or the force applied to the shanks 46 to be adjusted. Similarly, the implement 12 may include one or more second actuators 58 coupled to the disk forward frame 42 to adjust the penetration depth of and/or the force applied to the disk blades 50. Moreover, the implement 12 may include one or more third actuators 60 coupled to the aft frame 44 to allow the aft frame 44 to be moved relative to the central frame 40, thereby allowing adjustment of the relevant operating parameters of (e.g., the force applied to and/or the penetration depth of) the ground-engaging tools 52, 54 supported by the aft frame 44.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration. For example, in an alternative embodiment, a separate frame or chassis may be provided to which the engine, transmission, and drive axle assembly are coupled, a configuration common in smaller tractors. Still other configurations may use an articulated chassis to steer the work vehicle 10 or rely on tires/wheels in lieu of the track assemblies 14, 16.

It should also be appreciated that the configuration of the implement 12 described above and shown in FIGS. 1 and 2 is only provided for exemplary purposes. Thus, it should be appreciated that the present subject matter may be readily adaptable to any manner of implement configuration. For example, as indicated above, each frame section of the implement 12 may be configured to support any suitable type of ground-engaging tools, such as by installing closing disks on the aft frame 44 of the implement 12.

Additionally, in accordance with aspects of the present subject matter, the work vehicle 10 and/or the implement 12 may include one or more imaging devices coupled thereto and/or supported thereon. As will be described below, each imaging device may be configured to capture image data (e.g., images) associated with a portion of the field across which the vehicle/implement 10/12 is traveling. The captured image data may, in turn, be indicative of one or more parameters or characteristics of the field, such the surface roughness/profile, clod size, and/or residue coverage of the field. As such, in several embodiments, the imaging device(s) may be provided in operative association with the vehicle/implement 10/12 such that the device(s) has an associated field(s) of view or sensor detection range(s) directed towards a portion(s) of the field adjacent to the vehicle/implement 10/12. For example, as shown in FIG. 1, in one embodiment, one imaging device 102A may be mounted on a forward end 62 of the work vehicle 10 to capture image data associated with a portion of the field disposed in front of the vehicle 10 relative to the direction of travel 34. Similarly, as shown in FIGS. 1 and 2, a second imaging device 102B may be mounted on an aft end 64 of the implement 12 to capture image data associated with a portion of the field disposed behind the implement 12 relative to the direction of travel 34. However, in alternative embodiments, the imaging devices 102A, 102B may be installed at any other suitable location(s) on the vehicle/implement 10/12. Additionally, in some embodiments, the vehicle/implement 10/12 may include only one imaging device or three or more imaging devices.

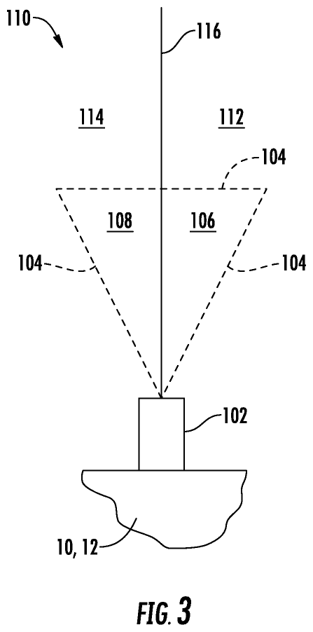

Referring now to FIG. 3, a top view of one embodiment of an imaging device 102 of the vehicle/implement 10/12 is illustrated in accordance with aspects of the present subject matter. In general, the imaging device 102 may be coupled to or installed on the vehicle/implement 10/12 such that the imaging device 102 has a field of view (e.g., as indicated by lines 104 in FIG. 3) directed to a portion of the field across which the vehicle/implement 10/12 is traveling. Specifically, in several embodiments, the field of view 104 of the imaging device 102 may be directed at a processed portion of the field (e.g., a portion of the field on which an agricultural operation has already been performed) and an unprocessed portion of the field (e.g., a portion of the field on which the agricultural operation has not yet been performed). As such, the field of view of the imaging device 102 may include a first section 106 directed one of the processed or unprocessed portions of the field and a second section 108 directed at the other of the processed or unprocessed portions of the field. For example, FIG. 3 illustrates a field 110 having a processed portion 112 and an unprocessed portion 114, with the processed and unprocessed portions 112, 114 being separated by line 116. As shown, the first section 106 of the field of view 104 of the imaging device 102 may be directed at the processed portion 112 of the field 110. Conversely, the second section 108 of the field of view 104 of the imaging device 102 may be directed at the unprocessed portion 114 of the field 110. In this respect, each image captured by the imaging device 102 may include a first portion associated with the processed portion of the field and a second portion associated with the unprocessed portion of the field. Thus, the imaging device 102 may be able to simultaneously capture image data associated with the processed and unprocessed portions of the field.

By capturing image data associated with the processed and unprocessed portions of the field as the vehicle/implement 10/12 travels across the field to perform an agricultural operation thereon, the performance of the agricultural operation may be assessed. As will be described below, the first portion of the image data associated with the processed portion of the field may be analyzed to determine a first value of a field characteristic (e.g., surface roughness/profile, clod size, and/or residue coverage) of the field. Furthermore, the second portion of the image data associated with the unprocessed portion of the field may be analyzed to determine or estimate a second value of the field characteristic of the field. Thereafter, a differential between the first and second field characteristic values may be determined, with such differential being indicative of the performance of the agricultural operation.

It should be appreciated that positioning the imaging device 102 such that its field of view 104 is directed to both processed and unprocessed portions of the field may generally reduce the number of imaging devices needed to assess the performance of an agricultural operation. That is, a single imaging device 102 may be able to capture image data associated with the processed and unprocessed portions of the field. This may, in turn, may decrease the amount of image data captured when assessing agricultural operation performance and, as a result, reduce the amount of processing power and memory needed to make such assessment. In addition, installing fewer imaging devices on the vehicle/implement 10/12 may reduce the overall cost of the vehicle/implement 10/12.

Furthermore, it should be appreciated that the imaging device 102 may correspond to any suitable device(s) configured to capture images or other image data of the surface of the field that allows one or more characteristics (e.g., surface roughness/profile, clod size, and/or residue coverage) of the field to be identified. For instance, in several embodiments, the imaging device 102 may correspond to any suitable camera, such as single-spectrum camera or a multi-spectrum camera configured to capture images in the visible light range and/or infrared spectral ranges. Additionally, in one embodiment, the camera may correspond to a single lens camera configured to capture two-dimensional images or a stereo camera having two or more lenses with a separate image sensor for each lens to allow the camera to capture stereographic or three-dimensional images. Alternatively, the imaging device 102 may correspond to any other suitable image capture device and/or vision system that is capable of capturing “images” or other image-like data that allows one or more characteristics of the field to be identified. For example, in one embodiment, the imaging device 102 may correspond to a light detection and ranging (LIDAR) device or a radio detection and ranging device (RADAR) device.

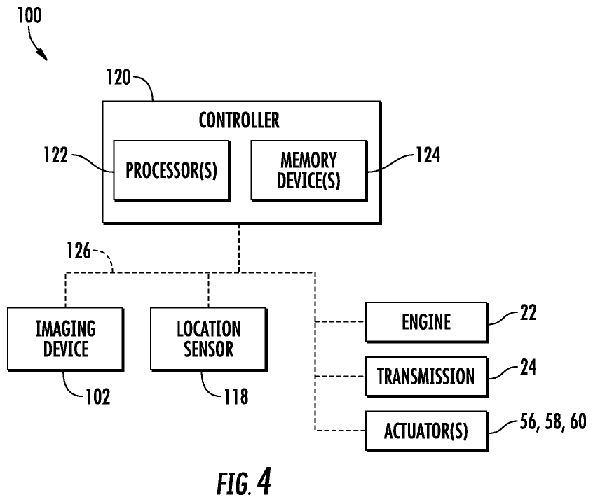

Referring now to FIG. 4, a schematic view of one embodiment of a system 100 for assessing agricultural operation performance is illustrated in accordance with aspects of the present subject matter. In general, the system 100 will be described herein with reference to the work vehicle 10 and the agricultural implement 12 described above with reference to FIGS. 1-3. However, it should be appreciated by those of ordinary skill in the art that the disclosed system 100 may generally be utilized with work vehicles having any other suitable vehicle configuration and/or agricultural implements having any other suitable implement configuration.

As shown in FIG. 4, the system 100 may include a location sensor 118 provided in operative association with the vehicle 10 and/or the implement 12. In general, the location sensor 118 may be configured to determine the current location of the vehicle 10 and/or the implement 12 using a satellite navigation positioning system (e.g. a GPS system, a Galileo positioning system, the Global Navigation satellite system (GLONASS), the BeiDou Satellite Navigation and Positioning system, and/or the like). In such an embodiment, the location determined by the location sensor 118 may be transmitted to a controller(s) of the vehicle 10 and/or the implement 12 (e.g., in the form coordinates) and stored within the controller's memory for subsequent processing and/or analysis. For instance, based on the known dimensional configuration and/or relative positioning between the vehicle 10 and the implement 12, the determined location from the location sensor 118 may be used to geo-locate the implement 12 within the field.

In accordance with aspects of the present subject matter, the system 100 may include a controller 120 positioned on and/or within or otherwise associated with the vehicle 10 or the implement 12. In general, the controller 120 may comprise any suitable processor-based device known in the art, such as a computing device or any suitable combination of computing devices. Thus, in several embodiments, the controller 120 may include one or more processor(s) 122 and associated memory device(s) 124 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 124 of the controller 120 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 124 may generally be configured to store suitable computer-readable instructions that, when implemented by the processor(s) 122, configure the controller 120 to perform various computer-implemented functions.

In addition, the controller 120 may also include various other suitable components, such as a communications circuit or module, a network interface, one or more input/output channels, a data/control bus and/or the like, to allow controller 120 to be communicatively coupled to any of the various other system components described herein (e.g., the engine 22; the transmission 24; the actuators 56, 58, 60; the imaging device(s) 102, and the location sensor 102). For instance, as shown in FIG. 4, a communicative link or interface 126 (e.g., a data bus) may be provided between the controller 120 and the components 22, 24, 56, 58, 60, 102, 118 to allow the controller 120 to communicate with such components 22, 24, 56, 58, 60, 102, 118 via any suitable communications protocol (e.g., CANBUS).

It should be appreciated that the controller 120 may correspond to an existing controller(s) of the vehicle 10 and/or the controller 12, itself, or the controller 120 may correspond to a separate processing device. For instance, in one embodiment, the controller 120 may form all or part of a separate plug-in module that may be installed in association with the vehicle 10 and/or the controller 12 to allow for the disclosed systems to be implemented without requiring additional software to be uploaded onto existing control devices of the vehicle 10 and/or the controller 12. It should also be appreciated that the functions of the controller 120 may be performed by a single processor-based device or may be distributed across any number of processor-based devices, in which instance such devices may be considered to form part of the controller 120. For instance, the functions of the controller 108 may be distributed across multiple application-specific controllers, such as a navigation controller, an engine controller, an implement controller, and/or the like.

In several embodiments, the controller 120 may be configured to receive image data associated with the processed and unprocessed portions of the field across which the vehicle/implement 10/12 is traveling. As described above, one or more imaging devices 102 may be installed on the vehicle 10 and/or the implement 12 such that the imaging device(s) 102 has a field(s) of view directed at a portion of the field adjacent to the vehicle/implement 10/12. Specifically, each imaging device 102 is positioned such that its field of view includes a first section directed at one of a processed portion of the field or an unprocessed portion of the field and a second section directed at the other of the processed portion of the field or the unprocessed portion of the field. As such, each image captured by the imaging device(s) 102 may include a first portion depicting or otherwise associated with the processed portion of the field and a second portion depicting or otherwise associated with the unprocessed portion of the field. In this respect, as the vehicle/implement 10/12 travels across the field to perform an agricultural operation (e.g., a tillage operation, a seeding operation, and/or the like) thereon, the controller 120 may be configured to receive image data from the imaging device(s) 102 (e.g., via the communicative link 126). As will be described below, the received image data may be analyzed or processed to assess the performance of the agricultural operation being performed on the field. For example, by receiving a single image depicting both the processed and unprocessed portions of the field, the controller 120 may receive less data when assessing the performance of the agricultural operation being performed, thereby requiring less processing power and memory.

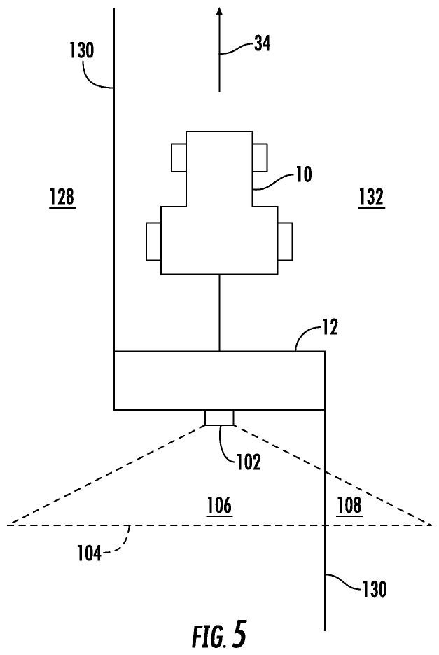

FIG. 5 illustrates a diagrammatic view of the vehicle 10 towing the implement 12 across a field in the direction of travel 24 to perform an agricultural operation (e.g., a tillage operation, a seeding operation, and/or the like) thereon. As shown, the field includes a processed portion 128 located to the left of the vehicle/implement 10/12 and aft of the implement 12 (e.g., to the left of lines 130 in FIG. 5). Additionally, the field includes an unprocessed portion 132 located to the right of the vehicle/implement 10/12 and forward of the implement 12 (e.g., to the right of lines 130 in FIG. 5). In this respect, an imaging device 102 may be installed on the implement 12 such that the imaging device 102 has a field of view 104 directed at a portion of the field aft of the implement 12. Specifically, in the instance shown in FIG. 5, the imaging device 102 may be positioned such that its field of view 104 includes a first section 106 directed at the processed portion 128 of the field and a second section 108 directed at the unprocessed portion 132 of the field. As such, each image captured by the imaging device 102 may include a first portion indicative of the characteristic(s) of the field present within the first section 106 of the field of view 104 of the imaging device 102. Furthermore, each image may include a second portion indicative of the characteristic(s) of the field present within the second section 108 of the field of view 104 of the imaging device 102. Thus, the first portion of each captured image may be associated with the characteristic(s) of the processed portion 128 of the field, while the second portion of each captured image may be associated with the characteristic(s) of the unprocessed portion 132 of the field. As will be described below, when the vehicle/implement 10/12 reverses its direction of travel 34 (e.g., to make another pass across the field), the first section 106 of the field of view 104 of the imaging device 102 may be directed at the unprocessed portion 132 of the field, while the second section 108 of the field of view 104 of the imaging device 102 may be directed at the processed portion 128 of the field.

It should be appreciated that the “processed portion” of the field may refer to any portion or section of the field on which the current agricultural operation has already been performed. Conversely, the “unprocessed portion” of the field may refer to any portion or section of the field on which the current agricultural operation has not yet been performed. In this respect, when the vehicle/implement 10/12 is traveling across the field to perform an agricultural operation thereon, the processed portion of the field may refer to the portion of the field across which the vehicle/implement 10/12 has already traveled to perform the operation to perform such operation (e.g., the portion of the field behind of the vehicle/implement 10/12), while the unprocessed portion of the field may refer to the portion of the field across which the vehicle/implement 10/12 has not yet traveled to perform the operation to perform such operation (e.g., the portion of the field in front of the vehicle/implement 10/12). As such, it should be appreciated that, although the current agricultural operation (e.g., a seeding operation) being performed on the field has not yet been performed on the unprocessed portion of the field, previous agricultural operation(s) (e.g., a tillage operation) may have been performed on the unprocessed portion of the field.

Referring again to FIG. 4, the controller 120 may be configured to identify a first portion of the image data that is associated with the processed portion of the field and a second portion of the image data that is associated with the unprocessed portion of the field. More specifically, the first section of the field of view of each imaging device 102 may be directed at the processed portion of the field when the vehicle/implement 10/12 is traveling across the field in a first direction and directed at the unprocessed portion of the field when the vehicle/implement 10/12 is traveling across the field in an opposite, second direction. Similarly, the second section of the field of view of each imaging device 102 may be directed at the unprocessed portion of the field when the vehicle/implement 10/12 is traveling across the field in the first direction and directed at the processed portion of the field when the vehicle/implement 10/12 is traveling across the field in the opposite, second direction. As such, the controller 120 may be configured to process or analyze the received image data to identify the first and second portions of such data.

In several embodiments, the controller may be configured to identify the first and second portions of the received image data based on a field map. More specifically, in such embodiment, a field map having one or more guidance or swath lines that the vehicle/implement 10/12 follows across the field when performing the agricultural operation may be stored within the memory device(s) 124 of the controller 120. Furthermore, as the vehicle/implement 10/12 travel across the field, the controller 120 may be configured to receive location data (e.g., coordinates) associated with the current location of the vehicle/implement 10/12 within the field. In this respect, the controller 120 may be configured to determine the specific direction of travel across the field based on the received location data and the stored field map. For example, the controller 120 may be configured to identify the specific guide/swath line depicted in the field map on which the vehicle/implement 10/12 is currently traveling based on the received location data, with the identified guide/swath line providing the specific direction of travel across the field. Thereafter, based on the specific direction of travel of the vehicle/implement 10/12 across the field and the known positioning of the imaging device(s) 102 and the associated field(s) of view, the controller 120 may be able to identify which portion of each received image is associated with the processed portion of the field and which portion of each received image is associated with the unprocessed portion of the field. However, in alternative embodiments, the controller 120 may be configured to identify the first and second portions of the received image data in any other suitable manner.

Additionally, the controller 120 may be configured to partition or otherwise divide the first portion of the image data that is associated with the processed portion of the field and the second portion of the image data that is associated with the unprocessed portion of the field. For example, the controller 120 may be configured to partition or divide the pixels of each received image that are associated with the processed portion of the field from the pixels of each received image that are associated with the unprocessed portion of the field. For instance, the controller 120 may include one or more algorithm(s) stored within its memory device(s) 124 that, when executed by the processor(s) 122, allow the controller 120 to partition the received image data. Partitioning the received image data as described above may simplify the subsequent determinations of the field characteristic(s) of the processed and unprocessed portions of the field, thereby requiring less processing power and memory.

In accordance with aspects of the present subject matter, the controller 120 may be configured to determine first and second values of one or more field characteristics of the field based on the received image data. In general, the first value(s) may be associated with the field characteristic(s) of the processed portion of the field, while the second value(s) may be associated with the field characteristic(s) of the unprocessed portion of the field. Specifically, in several embodiments, the controller 120 may be configured to analyze or process the first portion of the received image data to determine the first value(s) of the field characteristic(s). Moreover, the controller 120 may be configured to analyze or process the second portion of the received image data to determine the second value(s) of the field characteristic(s). For instance, the controller 120 may include one or more image data processing algorithm(s) stored within its memory device(s) 124 that, when executed by the processor(s) 122, allow the controller 120 to determine the first and second values of the field characteristic(s) based on the received image data. Thereafter, the controller 120 may be configured to compare the first and second values of each field characteristic to determine an associated field characteristic differential associated with the performance of the agricultural operation.

It should be appreciated that the field characteristic(s) may correspond to any suitable parameter(s) or value(s) associated with the field conditions(s). For example, in several embodiments, the field characteristic(s) may correspond to the soil surface roughness/profile (e.g., average or maximum amplitude of the surface profile), the clod size (e.g., the clod size distribution), and/or residue coverage (e.g., percent residue coverage) of the field. However, in alternative embodiments, the field characteristic(s) may correspond to any other suitable parameter(s)/value(s).

Furthermore, the controller 120 may be configured to actively adjust one or more operating parameters the vehicle 10 and/or the implement 12 based on the determined field characteristic differential(s). Specifically, in several embodiments, the controller 120 may be configured to compare the determined field characteristic differential(s) to a corresponding predetermined differential range associated with an acceptable or adequate level or agricultural operation performance. Thereafter, when the determined field characteristic differential(s) falls outside of the associated predetermined differential range (thereby indicating that the performance of the agricultural operation is not acceptable or satisfactory), the controller 120 may be configured to actively adjust one or more operating parameters of the vehicle 10 and/or the implement 12. In one embodiment, the controller 120 may be configured to initiate an adjustment of the force applied to and/or the penetrate depth of one or more ground-engaging tools (e.g., the disk blades 46, the shanks 48, the leveling blades 50, and/or the baskets 52) of the implement 12. For example, in such an embodiment, the controller 120 may be configured to transmit control signals to the associated actuators 56, 58, 60 (e.g., via the communicative link 126) instructing such actuators 56, 58, 60 to adjust the force applied to and/or the penetration depth(s) of the tool(s). Alternatively or in addition to adjusting the operating parameter(s) of the ground-engaging tool(s), the controller 120 may be configured to initiate an adjustment of the ground speed of the vehicle/implement 10/12. For example, in such an embodiment, the controller 120 may be configured to transmit control signals to the associated engine 22 and/or the transmission 24 (e.g., via the communicative link 126) instructing such devices 22, 24 to adjust the ground speed of the vehicle/implement 10/12. However, in alternative embodiments, the controller 120 may be configured to adjust any other suitable operating parameter(s) of the vehicle 10 and/or the implement 12.

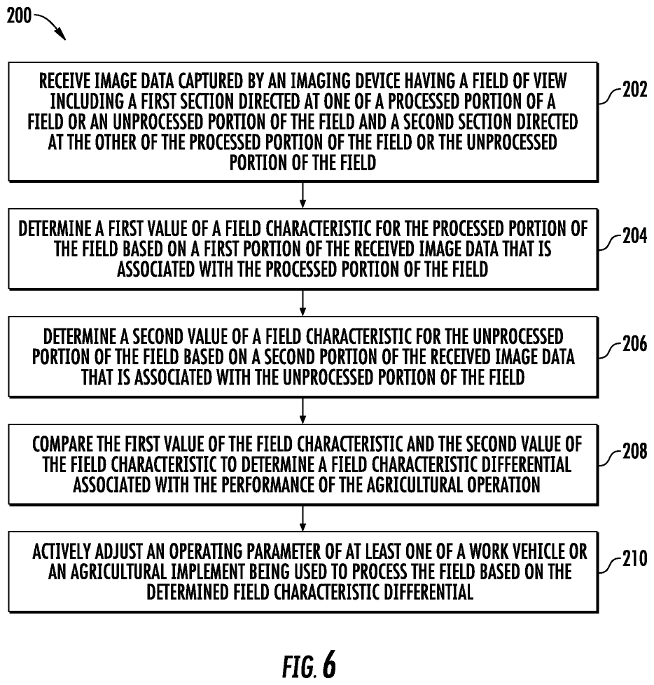

Referring now to FIG. 6, a flow diagram of one embodiment of a method 200 for assessing agricultural operation performance is illustrated in accordance with aspects of the present subject matter. In general, the method 200 will be described herein with reference to the work vehicle 10, the agricultural implement 12, and the system 100 described above with reference to FIGS. 1-5. However, it should be appreciated by those of ordinary skill in the art that the disclosed method 200 may generally be implemented with any work vehicle having any suitable vehicle configuration, with any agricultural implement having any suitable implement configuration, and/or within any system having any suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include receiving, with one or more computing devices, image data captured by an imaging device having a field of view including a first section directed at one of a processed portion of a field or an unprocessed portion of the field and a second section directed at the other of the processed portion of the field or the unprocessed portion of the field. For instance, as described above, the controller 120 may be configured to receive image data captured by one or more imaging device(s) 102 installed on a work vehicle 10 and/or an implement 12. Each imaging device 102 may, in turn, have a field of view 104 including a first section directed at one of a processed portion of a field or an unprocessed portion of the field and a second section directed at the other of the processed portion of the field or the unprocessed portion of the field.

Additionally, at (204), the method 200 may include determining, with the one or more computing devices, a first value of a field characteristic for the processed portion of the field based on a first portion of the received image data that is associated with the processed portion of the field. For instance, as described above, the controller 120 may be configured to determine a first value of a field characteristic for the processed portion of the field based on a first portion of the received image data that is associated with the processed portion of the field.

Moreover, as shown in FIG. 6, at (206), the method 200 may include determining, with the one or more computing devices, a second value of a field characteristic for the unprocessed portion of the field based on a second portion of the received image data that is associated with the unprocessed portion of the field. For instance, as described above, the controller 120 may be configured to determine a second value of a field characteristic for the unprocessed portion of the field based on a second portion of the received image data that is associated with the unprocessed portion of the field.

Furthermore, at (208), the method 200 may include comparing, with the one or more computing devices, the first value of the field characteristic and the second value of the field characteristic to determine a field characteristic differential associated with the performance of the agricultural operation. For instance, as described above, the controller 120 may be configured to compare the first and second values of the field characteristic to determine a field characteristic differential associated with the performance of the agricultural operation.

In addition, as shown in FIG. 6, at (210), the method 200 may include actively adjusting, with the one or more computing devices, an operating parameter of at least one of a work vehicle or an agricultural implement being used to process the field based on the determined field characteristic differential. For instance, as described above, the controller 120 may be configured to actively adjust one or more operating parameters of the work vehicle 10 and/or the implement 12 being used to process the field based on the determined field characteristic differential.

It is to be understood that the steps of the method 200 are performed by the controller 120 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 120 described herein, such as the method 200, is implemented in software code or instructions which are tangibly stored on a tangible computer readable medium. The controller 120 loads the software code or instructions via a direct interface with the computer readable medium or via a wired and/or wireless network. Upon loading and executing such software code or instructions by the controller 120, the controller 120 may perform any of the functionality of the controller 120 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for assessing agricultural operation performance, the system comprising:
an imaging device installed on a work vehicle or an agricultural implement, the imaging device configured to capture image data associated with a portion of a field present within a field of view of the imaging device, the field of view including a first section directed at one of a processed portion of the field or an unprocessed portion of the field and a second section directed at the other of the processed portion of the field or the unprocessed portion of the field; and
a controller communicatively coupled to the imaging device, the controller configured to:
determine a first value of a field characteristic for the processed portion of the field based on a first portion of the image data that is associated with the processed portion of the field; and
determine a second value of a field characteristic for the unprocessed portion of the field based on a second portion of the image data that is associated with the unprocessed portion of the field.

2. The system of claim 1, the controller is further configured to compare the first value of the field characteristic and the second value of the field characteristic to determine a field characteristic differential associated with the performance of the agricultural operation.

3. The system of claim 1, wherein the controller is further configured to actively adjust an operating parameter of at least one of the work vehicle or the agricultural implement based on the determined field characteristic differential.

4. The system of claim 3, wherein the controller is further configured to compare the determined field characteristic differential to a predetermined differential range and, when the determined field characteristic differential falls outside of the predetermined differential range, adjust the operating parameter.

5. The system of claim 3, wherein the operating parameter comprises at least of a ground speed of the work vehicle or a force being applied to a ground-engaging tool of the implement.

6. The system of claim 1, wherein the controller is further configured to:
receive, from the imaging device, image data captured as the agricultural implement is moved across the field; and
identify the first portion of the image data and the second portion of the image data.

7. The system of claim 6, wherein the controller is further configured to partition the identified first portion of the image data and the identified second portion of the image data.

8. The system of claim 1, wherein the controller is further configured to determine which of the first section of the field of view or the second section of the field view corresponds to the processed portion of the field and which of the first section of the field of view or the second section of the field view corresponds to the unprocessed portion of the field based on a field map of the field.

9. The system of claim 1, wherein the imaging device is installed on the agricultural implement such that the field of view of the vision-based sensor is directed aft of the agricultural implement relative to a direction of travel of the agricultural implement.

10. The system of claim 1, wherein the field characteristic comprises at least one of soil roughness, clod size, or residue coverage.

12. The system of claim 1, wherein the imaging device comprises a camera.

13. A method for assessing agricultural operation performance, the method comprising:
receiving, with one or more computing devices, image data captured by an imaging device having a field of view including a first section directed at one of a processed portion of a field or an unprocessed portion of the field and a second section directed at the other of the processed portion of the field or the unprocessed portion of the field;
determining, with the one or more computing devices, a first value of a field characteristic for the processed portion of the field based on a first portion of the received image data that is associated with the processed portion of the field;
determining, with the one or more computing devices, a second value of a field characteristic for the unprocessed portion of the field based on a second portion of the received image data that is associated with the unprocessed portion of the field;
comparing, with the one or more computing devices, the first value of the field characteristic and the second value of the field characteristic to determine a field characteristic differential associated with the performance of the agricultural operation; and
actively adjusting, with the one or more computing devices, an operating parameter of at least one of a work vehicle or an agricultural implement being used to process the field based on the determined field characteristic differential.

14. The method of claim 13, wherein actively adjusting the operating parameter comprises:
comparing, with the one or more computing devices, the determined field characteristic differential to a predetermined differential range; and
when the determined field characteristic differential falls outside of the predetermined differential range, adjusting, with the one or more computing devices, the operating parameter.

15. The method of claim 13, wherein the operating parameter comprises at least of a ground speed of the work vehicle or a force being applied to a ground-engaging tool of the implement.

16. The method of claim 13, further comprising:
identifying, with the one or more computing devices, the first portion of the image data and the second portion of the image data.

17. The method of claim 16, further comprising:
partitioning, with the one or more computing devices, the identified first portion of the image data and the identified second portion of the image data.

18. The method of claim 13, further comprising:
determining, with the one or more computing devices, which of the first section of the field of view or the second section of the field view corresponds to the processed portion of the field and which of the first section of the field of view or the second section of the field view corresponds to the unprocessed portion of the field based on a field map of the field.

19. The method of claim 13, wherein the field characteristic comprises at least one of soil roughness, clod size, or residue coverage.
